(19) United States
(12) Patent Application Publication
(10) Pub. No.: US 2026/0196601 A1
(43) Pub. Date: Jul. 9, 2026

(54) BATTERY PACK

(71) Applicants: HYUNDAI MOTOR COMPANY, SEOUL (KR); KIA CORPORATION, SEOUL (KR)

(72) Inventor: Do Han Kim, Hwaseong-si (KR)

(73) Assignees: HYUNDAI MOTOR COMPANY, SEOUL (KR); KIA CORPORATION, SEOUL (KR)

(21) Appl. No.: 19/226,617

(22) Filed: Jun. 3, 2025

(30) Foreign Application Priority Data
Jan. 3, 2025 (KR) 10-2025-0001141

(51) Int. Cl. H01M 10/6566; H01M 10/04; H01M 10/613; H01M 10/6565

(52) U.S. Cl. CPC H01M 10/6566; H01M 10/0404; H01M 10/613; H01M 10/6565

(57) ABSTRACT

A battery pack includes a battery module. The battery module includes a plurality of overlapping battery cells, and a plurality of cartridges interposed among the plurality of battery cells. The plurality of cartridges align in the same direction as the plurality of battery cells. The battery module also includes a punchable portion provided on at least one surface of a cartridge of the plurality of cartridge. The punchable portion is configured to be punchably pressed through the at least one surface of the cartridge to form a cooling hole.

### CROSS-REFERENCE TO RELATED APPLICATION

This application claims the benefit of and priority to Korean Patent Application No. 10-2025-0001141, filed on Jan. 3, 2025 in the Korean Intellectual Property Office, the disclosure of which is incorporated herein by reference in its entirety.

### BACKGROUND

### 1. Technical Field

The present disclosure relates to a battery pack, and more particular to technology associated with cooling of a battery pack.

### 2. Description of the Related Art

A battery pack is mounted in an electric vehicle or the like, and a battery module is accommodated in the battery pack. The battery module is configured by assembling a plurality of battery cells in an overlapping manner.

The battery pack includes: the battery module; a battery case configured to accommodate the battery module; a cooling device configured to cool the battery cells of the battery module; and the like.

The cooling device may employ air-cooling, water-cooling, and the like. The cooling device, which may employ air-cooling, includes a blower configured to flow air from an exterior of a battery case into an interior of the battery case, and discharge the introduced air to the exterior of the battery case after cooling the battery module in the battery case. The cooling device may also include a baffle configured to uniformly distribute the air blown by the blower to the plurality of battery cells of the battery module.

The above matters disclosed in this section are merely to enhance understanding of the general background of the disclosure and should not be taken as an acknowledgement or any form of suggestion that the matters form the related art already known to a person having ordinary skill in the art.

### SUMMARY

Therefore, the present disclosure has been made in view of the above problems, and it is an object of the present disclosure to provide a battery pack configured to easily flow air to uniformly cool battery cells accommodated in the battery pack, without mounting of a separate baffle in the battery pack. As a result, the battery pack may be capable of reducing the number of parts required for the battery pack, and eliminating air flow disturbance caused by installation of a baffle in a conventional case, thus enhancing cooling performance for the battery cells.

Objects of the present disclosure are not limited to the above-described object, and other objects of the present disclosure not yet described should be more clearly understood by those having ordinary skill in the art from the following detailed description.

In accordance with an aspect of the present disclosure, the above and other objects can be accomplished by the provision of a battery pack including a battery module. The battery module includes a plurality of overlapping battery cells, and a plurality of cartridges interposed among the plurality of battery cells. The plurality of cartridges is aligned in the same direction as the plurality of battery cells. Additionally, the battery module includes a punchable portion provided on at least one surface of a cartridge of the plurality of cartridges. The punchable portion is configured to be punchably pressed through the at least one surface of the cartridge to form a cooling hole.

The cartridge includes a cooling slot positioned on an interior surface of the cartridge. The cooling slot is configured to direct air to flow into and through the cooling hole such that the air flows over and contacts the plurality of battery cells.

The cooling slot is formed among a plurality of support bars interconnecting two facing surfaces of the cartridge.

The punchable portion is disposed at a first end of the cooling slot, and a discharge hole is disposed at a second end of the cooling slot to discharge air directed through the cooling hole formed through punching of the punchable portion.

The punchable portion may be formed to have a shape surrounded by a perforation line.

The perforation line may be formed through formation of the cartridge such that a cross-sectional thickness of the cartridge is locally reduced along the perforation line.

The perforation line may be formed to have a shape in which a plurality of perforation holes and a plurality of bridges are alternately disposed.

The punchable portion may be formed through formation of the cartridge such that a cross-sectional thickness of the cartridge is locally reduced at the punchable portion.

The battery pack may further include a battery case configured to accommodate the battery module and to enable air from an exterior of the battery case to be supplied toward the punchable portion of the cartridge. The battery pack may further include a blower configured to discharge air flowing through the cooling hole of the cartridge to the exterior.

The battery case may include an upper case configured to enclose an upper surface of the battery module. The upper case includes a pack inlet configured to suction air. The battery case may also include a lower case disposed under the upper case. The lower case includes at least a portion of a discharge flow passage configured to enable air used to cool the plurality of battery cells while passing through the cooling hole to flow toward the blower after being converged.

The battery module may be installed in the battery pack to partition an internal space of the upper case, fluidly communicating with the pack inlet, from an internal space of the lower case, fluidly communicating with the discharge flow passage such that air suctioned into the pack inlet flows to the discharge flow passage through the cooling hole of the battery module.

In accordance with another aspect of the present disclosure, there is provided a battery module including a plurality of overlapping battery cells, and a plurality of cartridges interposed among the plurality of battery cells. The plurality of cartridges align in a same direction as the plurality of battery cells. The battery module also includes a punchable portion provided on at least one surface of a cartridge of the plurality of cartridges. The punchable portion is configured to be punchably pressed through the at least one surface of the cartridge to form a cooling hole.

The cartridge may include a cooling slot position on an interior surface of the cartridge. The cooling slot is configured to direct air flow into and through the cooling hole such that the air flows over and contacts the plurality of battery cells.

The cooling slot may be formed among a plurality of support bars interconnecting two facing surfaces of the cartridge.

The punchable portion may be disposed at a first end of the cooling slot, and a discharge hole may be disposed at a second end of the cooling slot to discharge air directed through the cooling hole formed through punching of the punchable portion.

The punchable portion may be formed to have a shape surrounded by a perforation line.

In accordance with another aspect of the present disclosure, there is provided a method of manufacturing a battery pack. The method includes forming a battery module by overlapping a plurality of battery cells and a plurality of cartridges with each other such that the plurality of battery cells and the plurality of cartridges are repeatedly disposed. The method also includes forming a plurality of cooling holes all at once by applying, by a punching jig, pressure to selected punchable portions of the plurality of cartridges, thereby punching the selected punchable portions at once.

A plurality of hole formation protrusions configured to form the cooling holes by pressing the selected punchable portions may be provided at the punching jig.

The method may further include seating, on a lower case, the battery module with the cooling holes formed through punching, and assembling, to an upper side of the battery module, an upper case provided with a pack inlet configured to receive air to be supplied to the cooling holes.

The battery module may be seated on the lower case such that at least a portion of a discharge flow passage configured to enable air flowing through the plurality of cooling holes of the battery module to flow toward a blower after being converged is formed between the battery module and the lower case.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a sectional view illustrating a structure of a battery pack according an embodiment of the present disclosure;

FIG. 2 is a perspective view showing a battery module of FIG. 1;

FIG. 3 is a view showing a part of the battery module of FIG. 2;

FIG. 4 is a view showing a part of a plurality of cartridges and a part of battery cells shown in FIG. 3;

FIG. 5 is a view showing one cartridge of FIG. 4;

FIG. 6 is a view showing a longitudinal cross-section of the cartridge of FIG. 5;

FIG. 7 is a view illustrating a first embodiment of a punchable portion provided at one surface of a cartridge in according to an embodiment of the present disclosure;

FIG. 8 is a view illustrating a state in which a part of the punchable portion of FIG. 7 is punched to form cooling holes;

FIG. 9 is a cross-sectional view taken along line IX-IX in FIG. 7;

FIG. 10 is a view showing an embodiment of a perforation line configured to form a punchable portion according to an embodiment of the present disclosure;

FIG. 11 is a view showing another embodiment of a punchable portion of a cartridge according an embodiment of the present disclosure;

FIG. 12 is a view explaining a machining of a cooling hole through pressing of a punchable portion of a battery module by a punching jig according to an embodiment of the present disclosure;

FIG. 13 is a view showing an example of a punching jig;

FIG. 14 is a view illustrating a discharge hole formed at a lower surface of a cartridge according to an embodiment of the present disclosure; and

FIG. 15 is a flowchart illustrating a battery pack manufacturing method according to an embodiment of the present disclosure.

### DETAILED DESCRIPTION

In the following description of the embodiments of the present disclosure, a detailed description of known technologies incorporated herein has been omitted where it may obscure the subject matter of the embodiments of the present disclosure. In addition, the embodiments of the present disclosure should be more clearly understood from the accompanying drawings and should not be limited by the accompanying drawings. Furthermore, it should be appreciated that all changes, equivalents, and substitutes that do not depart from the spirit and technical scope of the present disclosure are encompassed in the present disclosure.

It should be understood that, although the terms “first,” “second,” and the like may be used herein to describe various elements, these elements should not be limited by these terms. These terms are only used to distinguish one element from another.

Unless clearly used otherwise, singular expressions include a plural meaning.

In this specification, the term “comprising,” “including,” or the like, is intended to express the existence of the characteristic, the numeral, the step, the operation, the element, the part, or the combination thereof, and does not exclude another characteristic, numeral, step, operation, element, part, or any combination thereof, or any addition thereto.

The suffixes “module” and “unit” of elements herein are used for convenience of description and thus can be used interchangeably and do not have any distinguishable meanings or functions.

In the case where an element is “coupled,” “connected,” or “linked” to another element, it should be understood that the element may be directly connected or linked to the other element, or another element may be present therebetween. Conversely, in the case where an element is “directly coupled,” “directly connected,” or “directly linked” to another element, it should be understood that no other element is present therebetween.

When a component, device, element, or the like of the present disclosure is described as having a purpose or performing an operation, function, or the like, the component, device, or element should be considered herein as being “configured to” meet that purpose or to perform that operation or function.

Any number of components or a variety of components of any one of the configurations disclosed in the present disclosure may be included in the present disclosure. Such components may include any combination of characterized parts disclosed in the present disclosure, and may be arranged to constitute any one of various configurations disclosed in the present disclosure. Not only structures and arrangements of the components of the present disclosure, but also concepts as to use and operation thereof, may be applied not only to particular embodiments discussed in the present disclosure, but also to embodiments of any numbers and in any combinations. In the following description, embodiments including various characterized parts having various arrangements should be described with reference to the accompanying drawings.

Hereinafter, various embodiments disclosed in the present disclosure are described in detail with reference to the accompanying drawings, and the same or similar elements are designated by the same reference numerals regardless of the numerals in the drawings and redundant description thereof have been omitted.

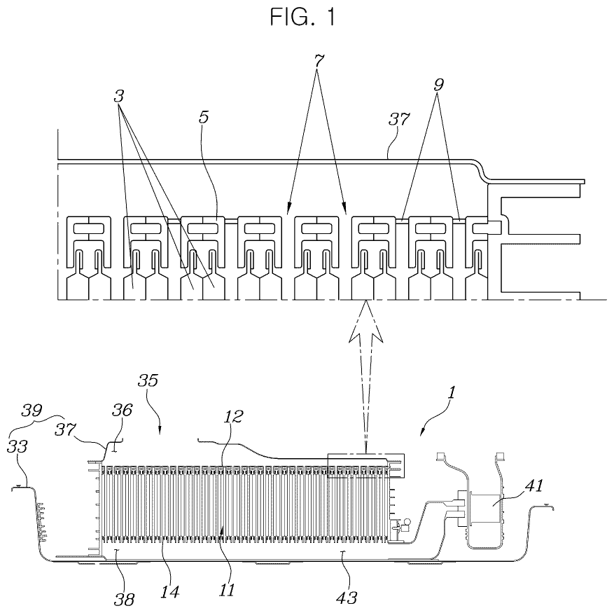

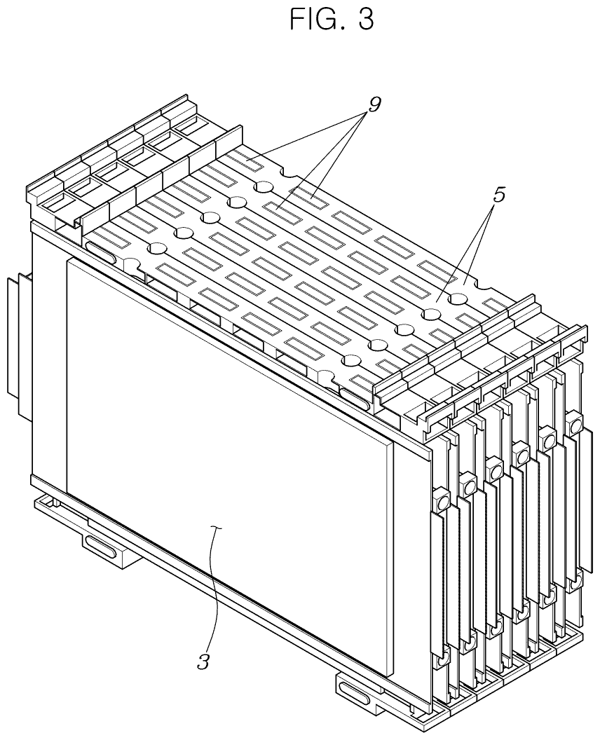

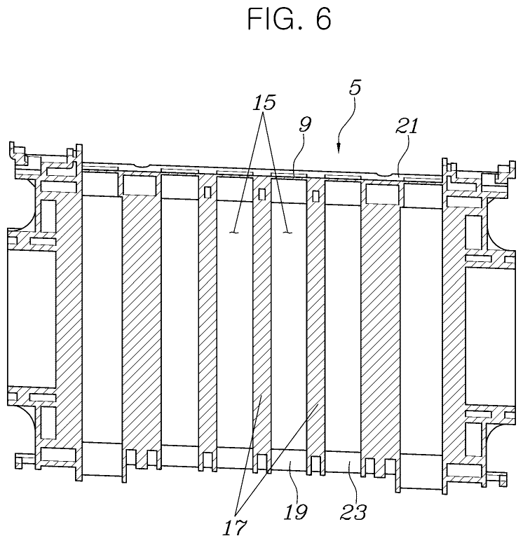

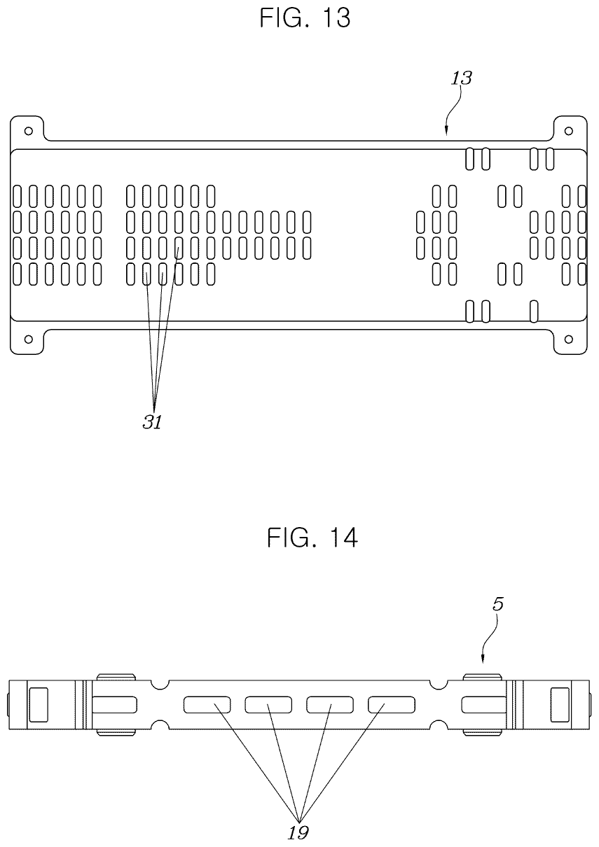

Referring to FIGS. 1-13, a battery pack 1 according to an embodiment of the present disclosure is configured to accommodate a battery module 11. The battery module 11 includes: a plurality of overlapping battery cells 3; a plurality of cartridges 5 interposed among the battery cells 3 and aligned (e.g., overlapping) in the same direction as the battery cells 3; and a punchable portion 9 formed on at least one surface of each cartridge 5, configured to be pressed (e.g., punchable through) to form a cooling hole 7.

The punchable portions 9 of the cartridges 5 may form respective cooling holes 7 when the punchable portions 9 are pressed by a punching jig 13, as is described below. In this case, air may flow through the cooling holes 7 and, as such, cool the battery cells 3 included in the battery module 11.

In other words, in the battery pack 1 that is configured to cool the battery cells 3 via a flow of air, it may be possible to secure uniform cooling performance for the battery cells 3 without provision of a separate baffle or the like configured to guide the flow of air. This is because the punchable portions 9 may function as a conventional baffle when the punchable portions 9 are maintained in an unpunched state (i.e., before the cooling holes 7 are formed).

Accordingly, since it may be possible to form a flow of air capable of uniformly cooling the battery cells 3 accommodated in the battery pack 1, without mounting of a separate baffle, the present disclosure may reduce the number of parts required for the battery pack 1 and may eliminate air flow disturbance caused by installation of a baffle in a conventional case. As a result, enhancing cooling performance for the battery cells 3 is provided.

Each cartridge 5 includes a cooling slot 15 formed at an interior side of the cartridge 5 and configured to enable air introduced thereinto through a corresponding one of the cooling holes 7 to be discharged after air flows over and contacts a corresponding one of the battery cells 3.

In other words, air introduced through a cooling hole 7 of the cartridge 5 cools the battery cell 3 disposed near (e.g., around) the cooling slot 15 while flowing through the cooling slot 15.

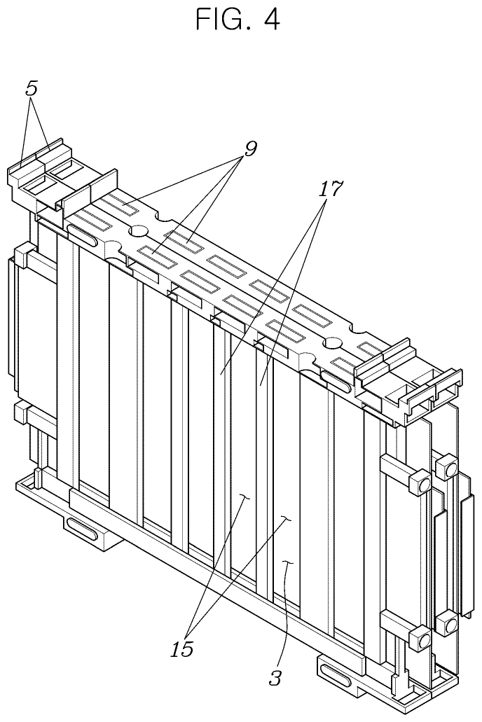

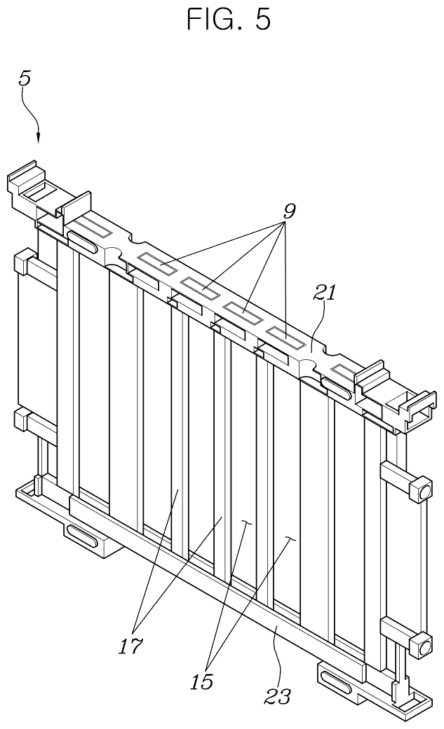

In this embodiment, as illustrated in FIGS. 4 and 5, the cartridge 5 is configured such that the cooling slot 15 is formed among a plurality of support bars 17 interconnecting two facing surfaces of the cartridge 5.

In the cartridge 5, the punchable portion 9 may be disposed at one end (e.g., a first end) of the cooling slot 15, and a discharge hole 19 may be disposed at the other end (e.g., a second end) of the cooling slot 15 to discharge air introduced into the cooling slot 15 through the cooling hole 7 formed in accordance with punching of the punchable portion 9.

In other words, one surface of the cartridge 5, at which the punchable portion 9 is formed, may be interpreted as an upper surface (e.g., a first end) of the cartridge 5, whereas the other surface of the cartridge 5 facing the upper surface of the cartridge 5 may be interpreted as a lower surface (e.g., a second end) of the cartridge 5. In other words, the punchable portion 9 is formed at an upper part 21 (e.g., a first end) of the cartridge 5 at which the upper surface of the cartridge 5 is formed, and the discharge hole 19 is formed at a lower part 23 (e.g., a second end) of the cartridge 5 at which the lower surface of the cartridge 5 is formed. Each support bar 17 is constituted by a linear member configured to vertically interconnect the upper part 21 and the lower part 23.

The discharge hole 19 may be previously formed at the lower part 23 of the cartridge 5 in order to eliminate the need for separate additional machining. Of course, the punchable portion 9 may also be formed at the lower part 23 of the cartridge 5 in order to form the discharge hole 19 through punching, if desired.

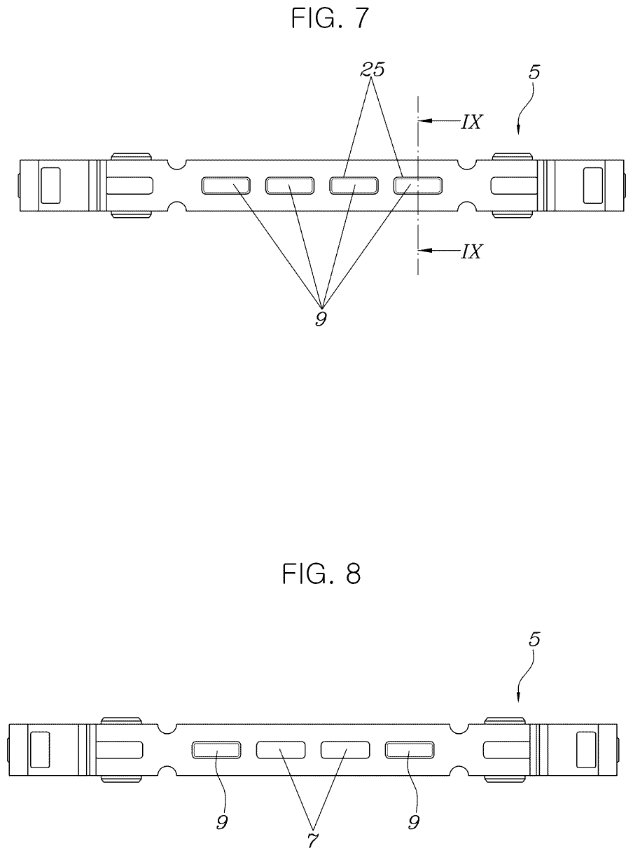

As shown in FIG. 7, the punchable portion 9 may be formed to have a shape surrounded by a perforation line 25.

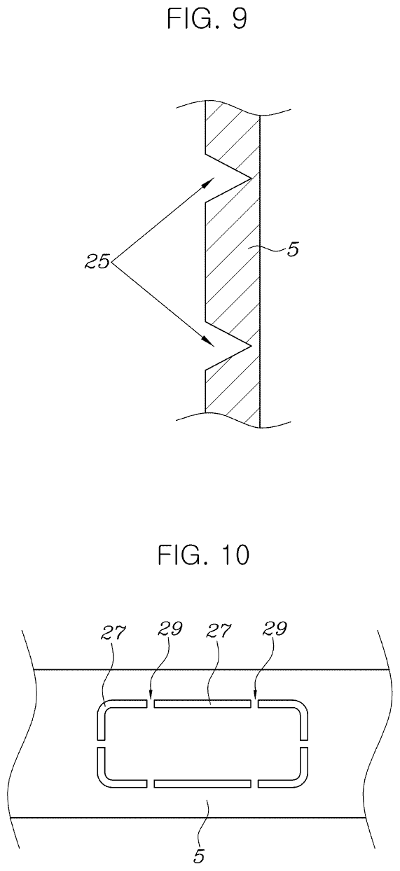

In addition, as illustrated in FIG. 9, the perforation line 25 may be configured through formation of the cartridge 5 such that the cross-sectional thickness of the cartridge 5 is locally reduced along the perforation line 25.

Accordingly, when a hole formation protrusion 31 of the punching jig 13, which is described below, presses the punchable portion 9, the perforation line 25 is easily fractured and, as such, the cooling hole 7 is formed, as shown in FIG. 8.

As shown in FIG. 10, the perforation line 25 may be formed to have a shape in which a plurality of perforation holes 27 and a plurality of bridges 29 are alternately disposed.

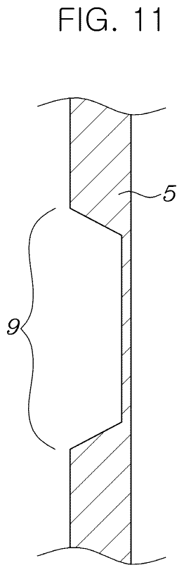

In addition, as illustrated in FIG. 11, the punchable portion 9 may be configured through formation of the cartridge 5 such that the cross-sectional thickness of the cartridge 5 is locally reduced at the punchable portion 9. In this case, it may be possible to form the cooling hole 7 by punching the portion of the cartridge 5 formed to have a locally-reduced cross-sectional thickness by the hole formation protrusion 31 of the punching jig 13.

When the punchable portion 9 and the perforation line 25 as described above are taken into consideration, it may be desired that the cartridge 5 be constituted by a plastic injection-molded product or the like.

FIG. 14 illustrates discharge holes 19 formed at the lower surface of the cartridge 5. As illustrated in FIG. 14, the discharge holes 19 are previously opened to correspond to all punchable portions 9 formed at the upper surface of the cartridge 5, respectively, in order to eliminate the need for an additional punching task.

As illustrated in FIG. 1, the battery pack 1 of the present disclosure further includes a battery case 39 formed to accommodate the battery module 11 therein. The battery case 39 is configured to enable air from the exterior (e.g., outside) of the battery case 39 to be supplied toward the punchable portion 9 of the cartridge 5. Additionally, the battery pack 1 includes a blower 41 installed to discharge air passing through the cooling hole 7 of the cartridge 5 to the exterior.

In this case, the battery case 39 includes an upper case 37 configured to enclose an upper surface 12 of the battery module 11 and formed with a pack inlet 35 configured to suction air. Additionally, the battery case 39 includes a lower case 33 disposed under the upper case 37 and configured to enclose a lower surface 14 of the battery module 11. The lower case 33 is also configured to form at least a portion of a discharge flow passage 43 configured to enable air used to cool the battery cells 3 while passing through the cooling hole 7 to flow toward the blower 41 after being converged.

In addition, the battery module 11 is installed in the battery pack 1 to partition an internal space (e.g., inner space) 36 of the upper case 37 communicating with the pack inlet 35 and an internal space 38 of the lower case 33 communicating with the discharge flow passage 43 from each other such that air suctioned into the pack inlet 35 moves to the discharge flow passage 43 only through the cooling hole 7 of the battery module 11.

Accordingly, when the blower 41 is driven, air introduced from the exterior into the pack inlet 35 flows through the cooling hole 7 of the battery module 11, and then flows toward the blower 41 through the discharge flow passage 43 after passing around the battery module 11.

In accordance with the battery pack structure as described above, air suctioned into the pack inlet 35 flows toward the blower 41 after passing around the battery module 11 through the cooling hole 7 of the battery module 11, and the blower 41 discharges the air to the exterior.

In this case, among the punchable portions 9 of the battery module 11, those not punched for formation of respective cooling holes 7 function to locally block a flow of air, like a conventional baffle. Consequently, the air introduced through the pack inlet 35 may form a flow capable of uniformly cooling all battery cells 3 constituting the battery pack.

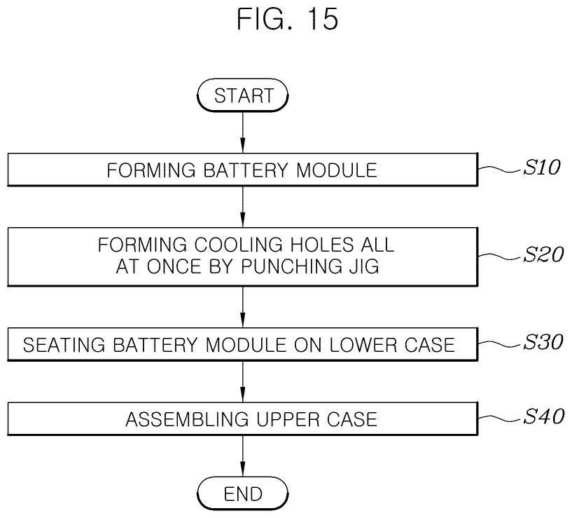

As illustrated in FIG. 15, a method of manufacturing the above-described battery pack in accordance with the present disclosure includes forming the battery module 11 by overlapping a plurality of battery cells 3 and a plurality of cartridges 5 with each other such that the battery cells 3 and the cartridges 5 are regularly repeatedly disposed (S10). The method also includes forming a plurality of cooling holes 7 all at once by applying, by a punching jig 13, pressure to selected ones of the punchable portions 9 of the plurality of cartridges 5 constituting the battery module 11, thereby punching the selected punchable portions 9 at once (S20).

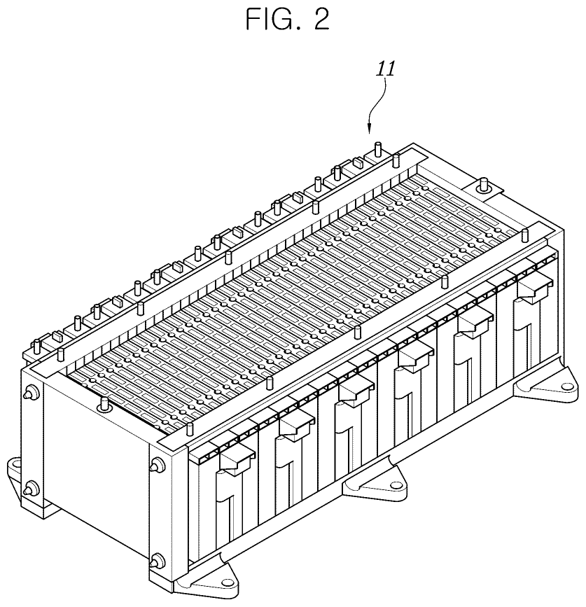

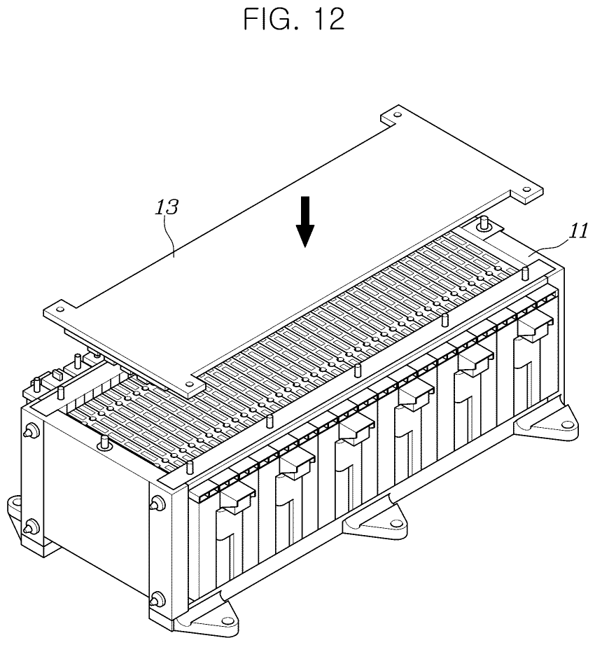

For reference, FIG. 2 shows the battery module 11 formed through the forming process (S10). FIG. 12 shows forming, at the battery module 11, the plurality of cooling holes 7 all at once using the punching jig 13 (S20).

A plurality of hole formation protrusions 31 configured to form the cooling holes 7 by pressing the selected punchable portions 9 is provided at the punching jig 13.

Of course, whether a part of the punchable portions 9 is punched to form the cooling holes 7 or is maintained without being punched is determined by presence or absence of the hole formation protrusions 31 of the punching jig 13. The hole formation protrusions 31 of the punching jig 13 are previously formed to enable the cooling holes 7 to be formed at positions capable of forming a most desirable flow of air in order to secure uniform cooling performance of all battery cells 3 constituting the battery module 11 in the battery pack, based on a plurality of experiments and interpretations.

In addition, the battery pack manufacturing method further includes seating, on the lower case 33, the battery module 11 with the cooling holes 7 punched by the punching jig 13, as described above (S30). The method also includes assembling, to an upper side of the battery module 11, the upper case 37 provided with a pack inlet 35 configured to receive air to be supplied to the cooling holes 7 (S40).

In the seating the battery module 11 on the lower case 33 (S30), the battery module 11 is seated on the lower case 33 such that at least a portion of the discharge flow passage 43 configured to enable air flowing through the plurality of cooling holes 7 of the battery module 11 to flow toward the blower 41 after being converged is formed between the battery module 11 and the lower case 33.

In the battery pack manufacturing method, the process of machining a part of the punchable portions 9 by the punching jig 13 to form the cooling holes 7 may be performed after the battery module 11 is seated on the lower case 33 and before the upper case 37 is assembled, if necessary.

In accordance with the present disclosure, it should be apparent that it may be possible to easily form a flow of air functioning to uniformly cool battery cells accommodated in the battery pack, without mounting of a separate baffle in the battery pack, thereby reducing the number of parts required for the battery pack. It may also be possible to eliminate air flow disturbance caused by installation of a baffle in a conventional case, thereby enhancing cooling performance for the battery cells.

Effects attainable in the present disclosure are not limited to the above-described effects, and other effects of the present disclosure not yet described should be more clearly understood by those having ordinary skill in the art from the above description.

Although the embodiments of the present disclosure have been disclosed for illustrative purposes, those having ordinary skill in the art should appreciate that various modifications, additions and substitutions are possible, without departing from the scope and spirit of the present disclosure as disclosed in the accompanying claims.

What is claimed is:

1. A battery pack comprising:
a battery module,
wherein the battery module includes:
a plurality of overlapping battery cells;
a plurality of cartridges interposed among the plurality of battery cells, the plurality of cartridges aligned in a same direction as the plurality of battery cells; and
a punchable portion provided on at least one surface of a cartridge of the plurality of cartridges, the punchable portion being configured to be punchably pressed through the at least one surface of the cartridge to form a cooling hole.

2. The battery pack according to claim 1, wherein the cartridge comprises a cooling slot positioned on an interior surface of the cartridge, the cooling slot being configured to direct air to flow into and through the cooling hole such that the air flows over and contacts the plurality of battery cells.

3. The battery pack according to claim 2, wherein the cooling slot is formed among a plurality of support bars interconnecting two facing surfaces of the cartridge.

4. The battery pack according to claim 3, wherein the punchable portion is disposed at a first end of the cooling slot, and a discharge hole is disposed at a second end of the cooling slot to discharge air directed through the cooling hole formed through punching of the punchable portion.

5. The battery pack according to claim 1, wherein the punchable portion is formed to have a shape surrounded by a perforation line.

6. The battery pack according to claim 5, wherein the perforation line is formed through formation of the cartridge such that a cross-sectional thickness of the cartridge is locally reduced along the perforation line.

7. The battery pack according to claim 5, wherein the perforation line is formed to have a shape in which a plurality of perforation holes and a plurality of bridges are alternately disposed.

8. The battery pack according to claim 1, wherein the punchable portion is formed through formation of the cartridge such that a cross-sectional thickness of the cartridge is locally reduced at the punchable portion.

9. The battery pack according to claim 1, further comprising:
a battery case configured to accommodate the battery module and to enable air from an exterior of the battery case to be supplied toward the punchable portion of the cartridge; and
a blower configured to discharge air flowing through the cooling hole of the cartridge to the exterior.

10. The battery pack according to claim 9, wherein the battery case comprises:
an upper case configured to enclose an upper surface of the battery module, the upper case including a pack inlet configured to suction air; and
a lower case disposed under the upper case, the lower case including at least a portion of a discharge flow passage configured to enable air used to cool the plurality of battery cells while passing through the cooling hole to flow toward the blower after being converged.

11. The battery pack according to claim 10, wherein the battery module is installed in the battery pack to partition an internal space of the upper case fluidly communicating with the pack inlet from an internal space of the lower case fluidly communicating with the discharge flow passage such that air suctioned into the pack inlet flows to the discharge flow passage through the cooling hole of the battery module.

12. A battery module comprising:
a plurality of overlapping battery cells;
a plurality of cartridges interposed among the plurality of battery cells, the plurality of cartridges aligned in a same direction as the plurality of battery cells; and
a punchable portion provided on at least one surface of a cartridge of the plurality of cartridges, the punchable portion being configured to be punchably pressed through the at least one surface of the cartridge to form a cooling hole.

13. The battery module according to claim 12, wherein the cartridge comprises a cooling slot positioned on an interior surface of the cartridge, the cooling slot being configured to direct air to flow into and through the cooling hole such that the air flows over and contacts the plurality of battery cells.

14. The battery module according to claim 13, wherein the cooling slot is formed among a plurality of support bars interconnecting two facing surfaces of the cartridge.

15. The battery module according to claim 14, wherein the punchable portion is disposed at a first end of the cooling slot, and a discharge hole is disposed at a second end of the cooling slot to discharge air directed through the cooling hole formed through punching of the punchable portion.

16. The battery module according to claim 12, wherein the punchable portion is formed to have a shape surrounded by a perforation line.

17. A method of manufacturing a battery pack, the method comprising:
forming a battery module by overlapping a plurality of battery cells and a plurality of cartridges with each other such that the plurality of battery cells and the plurality of cartridges are repeatedly disposed; and
forming a plurality of cooling holes all at once by applying, by a punching jig, pressure to selected punchable portions of the plurality of cartridges, thereby punching the selected punchable portions at once.

18. The method according to claim 17, wherein a plurality of hole formation protrusions configured to form the cooling holes by pressing the selected punchable portions is provided at the punching jig.

19. The method according to claim 17, further comprising:
seating, on a lower case, the battery module with the cooling holes formed through punching; and
assembling, to an upper side of the battery module, an upper case provided with a pack inlet configured to receive air to be supplied to the cooling holes.

20. The method according to claim 19, wherein the battery module is seated on the lower case such that at least a portion of a discharge flow passage configured to enable air flowing through the plurality of cooling holes of the battery module to flow toward a blower after being converged is formed between the battery module and the lower case.
